(19) United States
(12) Patent Application Publication
(10) Pub. No.: US 2002/0073361 A1
(43) Pub. Date: Jun. 13, 2002

(54) Method for controlling the program run in a microcontroller

(76) Inventor: Rainer Sommer, Stuttgart (DE)

Correspondence Address: KENYON & KENYON, ONE BROADWAY, NEW YORK, NY, 10004, US

(21) Appl. No.: 09/897,870

(22) Filed: Jul. 2, 2001

(30) Foreign Application Priority Data
Jun. 30, 2000 (DE) 100 30 980.1

(51) Int. Cl. H04L 1/22

(52) U.S. Cl. 714/38

(57) ABSTRACT

A method for controlling the run of a program executable on at least one microprocessor of a microcontroller. To control the run of a program executable on at least one microprocessor of a microcontroller to the greatest extent possible, so that the program can be flexibly adapted to different controller steps of a microcontroller, it is proposed that information regarding the hardware of the microcontroller be read in from at least one information register of the microcontroller, and that at least one switch via which the program run is controlled be actuated as a function of the information read in.

### FIELD OF THE INVENTION

The present invention relates to a method for controlling the run of a program executable on at least one microprocessor of a microcontroller. The present invention further relates to a microcontroller having at least one microprocessor, one program being executable on the at least one microprocessor. Finally, the present invention relates to a control element, in particular read only memory, random access memory, or flash memory. The control element is used in a control unit, in particular of a motor vehicle. Alternatively, the control element can also be used in a testing device for testing a microcontroller, a control unit, and/or a program executable on at least one microprocessor of the microcontroller.

### BACKGROUND OF THE INVENTION

From the related art, microcontrollers are known that include at least one microprocessor, an analog/digital (A/D) converter, a digital/analog (D/A) converter, a databus, internal control elements (e.g. a read only memory), and/or additional components. At least one such microcontroller is, for example, part of a control unit for a motor vehicle. The control unit is used for controlling/regulating technical operations and processes (internal combustion engine, transmission, chassis, air conditioner) in the motor vehicle. A control program for implementing the control/regulation is stored in a control element—an internal or external storage element—of the microcontroller. The control program can be executed on at least one of the microprocessors of the microcontroller. However, such a microcontroller can also be part of a control unit for any other control application/regulation application.

Microcontrollers from different manufacturers, but also microcontrollers from the same manufacturer, and even microcontrollers within one controller family from the same manufacturer can be configured differently with respect to hardware. The various microcontrollers differ with regard to the structural elements used, for example. The different versions of one microcontroller within one controller family are referred to as controller steps. The individual controller steps can have different scopes of functionalities (so-called features) and/or different faulty features. The faulty features are by-passed by way of so-called workarounds, in which case an attempt is made to simulate the faulty features using other features.

For example, microcontrollers are known where the A/D converter converts an analog value into a digital value, displays this value, and then triggers an interrupt by setting a bit. However, in the case of a microcontroller of a specific controller step, the error is known that no interrupt bit is set. This error can be avoided by setting the interrupt bit after a predefined period of time after the A/D conversion is begun. The time period is selected in such a manner that the A/D conversion is terminated even in the so-called worst case. Thus, the faulty, event-triggered interrupt is by-passed by a time-triggered interrupt.

In the case of other microcontrollers of a specific controller step, certain command sequences do not work. This error can be circumvented in that the faulty command sequences are avoided, and the functionality of these sequences is either not available or is emulated by other command sequences.

For the reasons described above of different features and workarounds, the program according to the related art, executable on the at least one microprocessor of the microcontroller is adapted to the particular controller step. However, the result is a plurality of different programs that all have to be maintained during software updates. If, in the case of a microcontroller, a new fuel-saving control program, for example, is to be implemented by a software update for a control unit of an internal combustion engine, the control programs of all of the controller steps are reworked and allocated to the corresponding microcontroller. This constitutes a significant expenditure of energy and money. Allocating the software updates to the different microcontrollers of the corresponding controller steps also represents a significant administrative expenditure.

Furthermore, microcontrollers are known from the related art that are part of a testing device for testing an additional microcontroller, a control unit, and/or a program executable on at least one microprocessor of the additional microcontroller. A test program is then stored in the control element of the microcontroller. The test program can be executed on at least one of the microprocessors of the microcontroller of the testing device. The additional microcontroller is, for example, part of a control unit for a motor vehicle. The testing device can be used to test the components fitted to the additional microcontroller or to the complete control unit and to test the control program of the additional microcontroller. For an optimum test of the additional microcontroller, of the control unit, and of the control program, the test program should be adapted to the controller step of the additional microcontroller of the control unit. According to the related art, either such an optimum test is omitted, or each controller step is provided with its own test program. The maintenance of these test programs is extremely labor and cost intensive. Microcontrollers are known from the related art that have so-called information registers in which information regarding the microcontroller hardware is stored. Preferably the information registers are only designed to be readable and include, for example, information regarding the manufacturer of the microcontroller, the manufacturing department or the manufacturing plant, the microcontroller model, the microcontroller family, the microcontroller step or the microcontroller inspection number, the size and type of internal storage element or the type of programming of the internal storage element. The information registers can be situated in the microcontroller outside of the microprocessor. However, they can also be a component of the microprocessor.

It is the object of the present invention to control the run of a program executable on at least one microprocessor of a microcontroller to the greatest extent possible, so that the program can be flexibly adapted to the different controller steps of a microcontroller.

To achieve this object, the present invention proposes based on the method of the type mentioned at the outset that information regarding the hardware of the microcontroller be read in from at least one information register of a microcontroller, and that, as a function of the information read in, at least one switch be actuated via which the run of the program is controlled.

### SUMMARY OF THE INVENTION

Therefore, the present invention proposes controlling the run of a program executable on the microcontroller by first ascertaining the hardware, for example, of the controller step of a microcontroller. The hardware of a microcontroller can be changed by fitting the controller with different components. However, microcontrollers are also known where the hardware can be configured by way of a programmable micro code, i.e., software. In the case of such microcontrollers, it is conceivable that in addition to the information from the information registers, information regarding the micro code is read in for controlling the program.

The microcontroller regarding whose hardware information is read in can be the microcontroller on which the program to be controlled is executed or also an additional microcontroller. Specific switches are then set as a function of the acquired hardware information in such a manner that certain workarounds and program features are activated or deactivated. The program run is, therefore, adapted to the hardware of a microcontroller.

The information to be read in, regarding the microcontroller includes, for example, the manufacture, model, type and size of the components used for the microcontroller. Exact details as to which features are present or not present for which information content or which errors occur for which information content and via which workarounds the errors can be by-passed are allocated to this information. It is conceivable that the content of the information register is retrieved for directly actuating the switch.

An advantageous embodiment of the present invention proposes that information be read in regarding at least one microprocessor of the microcontroller and/or at least one additional component of the microcontroller. The additional component is configured, for example, as an internal storage element, an A/D converter, a D/A converter, or a databus, e.g. a controller area network (CAN) bus, of the additional microcontroller. In general, information regarding all of the additional components of the microcontroller that could necessitate the program run to be adapted, can be read in.

A preferred exemplary embodiment of the present invention proposes that the run of a test program executable on at least one microprocessor of the microcontroller of a test device, for testing an additional microcontroller, a control unit, and/or a control program executable on at least one microprocessor of the additional microcontroller be controlled as a function of the information regarding the hardware of the additional microcontroller. According to this specific embodiment, the microcontroller is, therefore, part of a testing device, and the additional microcontroller is part of a control unit for a motor vehicle. A test program, via which the additional microcontroller, the complete control unit, and a control program executable on at least one of the microprocessors of the additional microcontroller, respectively, can be executed on at least one of the microprocessors of the microcontroller.

The run of the test program is controlled and/or configured in dependence upon the hardware information about the additional microcontroller of the control unit. The test program can, therefore, be individually adapted to the hardware of the additional microcontroller. Test patterns adjusted in a targeted manner to the hardware can also be run through. As such, tests can be carried out in a significantly more thorough, more exact, and more reliable manner, and the testing process is significantly simplified, since a tester does not have to first select the corresponding test program for all hardware and every control program, respectively. Rather, according to the present method, this occurs fully automatically.

For example, different microcontroller steps of one controller family are known that differ in that, in one step, a storage element is positioned on-chip and, in another step, off-chip. Using the method according to the present invention, the test program can be particularly simply and reliably configured in correspondence with the particular microcontroller step, and the program run can be accordingly controlled.

An alternative specific embodiment of the present invention proposes that the run of a control program executable on at least one microprocessor of the microcontroller of a control unit, for controlling/regulating technical operations and processes, in particular in a motor vehicle, be controlled as a function of the information regarding the hardware of the microcontroller. According to this alternative specific embodiment, the microcontroller is, therefore, part of a control unit. A control program can be executed on at least one of the microprocessors of the microcontroller of the control unit. The run of the control program is controlled as a function of the hardware of the microcontroller on which the control program is executable. In this manner, a single control program can be used for different microcontrollers of different hardware. Only one control program is maintained. In the case of new controller steps, the control program is correspondingly expanded. The expansion consists especially of defining the switches and programming additional features and/or modifications (adding, removing, revising the program) regarding workarounds. As a result, software updates of the control program are significantly less complicated and less expensive to carry out.

Of particular importance is the realization of the method according to the present invention in the form of a control element that is provided for a control unit, in particular of a motor vehicle, or for a testing device for testing a microcontroller, a control unit, and/or a program executable on at least one microprocessor of the microcontroller. In this context, a program that can be executed on a computing element, in particular on a microprocessor, and is suitable for carrying out the method according to the present invention is stored on the control element. Thus, in this case, the present invention is implemented by a program stored on the control element, so that this control element provided with the program represents the present invention in the same manner as the method for whose implementation the program is suited. In particular, an electrical storage medium, e.g., a read only memory or a flash memory, can be used as the control element.

To achieve the object of the present invention, it is further proposed that the microcontroller have an arrangement reading in information regarding the hardware of one microcontroller from at least one information register of the microcontroller, as well as at least one switch actuatable as a function of the information read in, for controlling the run of the program executable on the at least one microprocessor of the microcontroller. An advantageous further refinement of the present invention proposes that the arrangement for inputting information read in information regarding at least one microprocessor of the microcontroller and/or regarding at least one additional component of the microcontroller. The information regarding the at least one additional component of the microcontroller advantageously includes information regarding an internal storage element, an analog/digital (A/D) converter, a digital/analog (D/A) converter, and/or at least one databus.

A preferred specific embodiment of the present invention proposes that the microcontrollers be part of a testing device for testing an additional microcontroller, a control unit, and/or a program executable on at least one microprocessor of the additional microcontroller. According to this specific embodiment, the microcontroller on which the program to be controlled is executed and the additional microcontroller on whose hardware the control of the program run is dependent are two separate microcontrollers. The run of a test program executable on the microcontroller is controlled as a function of the information read in regarding the additional microcontroller, e.g. of a control unit.

An alternative specific embodiment of the present invention proposes that the microcontroller be part of a control unit for controlling/regulating technical operations and processes, particularly in a motor vehicle. According to this alternative specific embodiment, the run of a control program executable on the microcontroller, for example, is controlled as a function of the information read in regarding this microcontroller.

### BRIEF DESCRIPTION OF THE DRAWINGS

FIG. 1 shows a microcontroller of the present invention, according to a first preferred specific embodiment of the present invention.

FIG. 2 shows a microcontroller of the present invention, according to a second preferred specific embodiment of the present invention.

FIG. 3 shows a flow diagram of the method according to the present invention, corresponding to a preferred specific embodiment.

### DETAILED DESCRIPTION

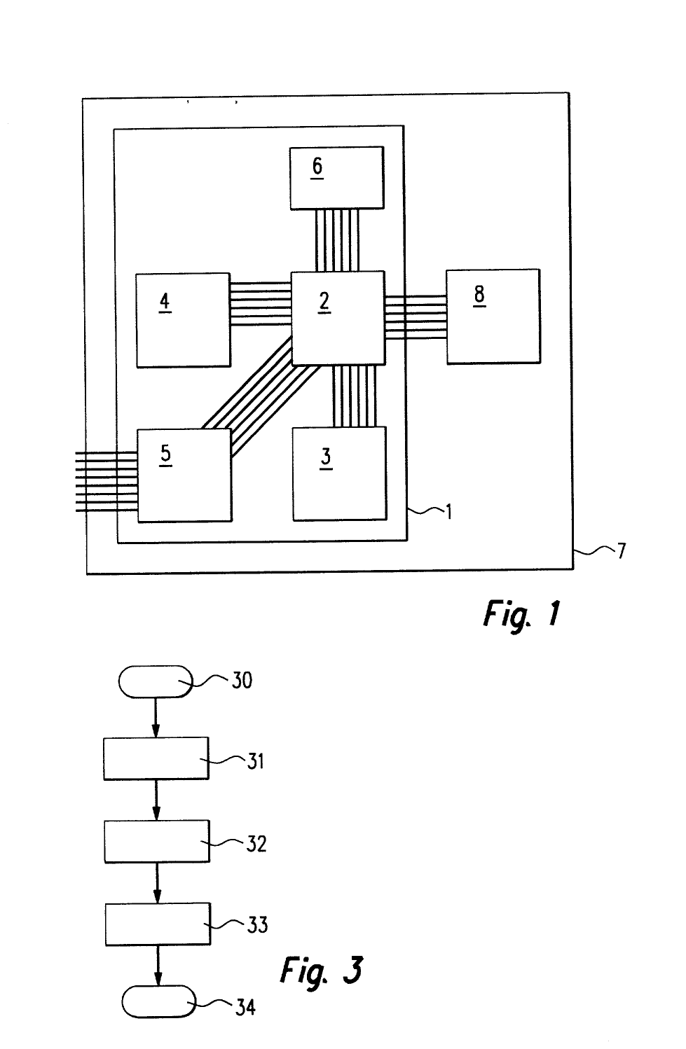

In FIG. 1, a microcontroller is designated in its entirety by reference numeral 1. Microcontroller 1 has a microprocessor 2, an internal storage element 3 configured as a flash memory, an analog/digital (A/D) converter 4, and a databus 5 configured as a controller area network (CAN) bus. Information regarding the hardware of the microcontroller is stored in a retrievable manner in an information register 6 of microcontroller 1.

Microcontrollers from different manufacturers, but also microcontrollers from the same manufacturer and even microcontrollers within one controller family from the same manufacturer can be differently configured with respect to hardware. The different microcontrollers differ due to the structural elements used, for example. The different versions of one microcontroller within one controller family are referred to as controller steps. The controller steps are again subdivided into different audits. The individual controller steps or audits can have different scopes of functionalities (so-called features) and/or different faulty features. The faulty features are by-passed by way of so-called workarounds, in which case an attempt is made to simulate the defective features using other features. The information stored in information register 6 includes, for example, information regarding the manufacturer of microcontroller 1, the manufacturing department or the manufacturing plant, the microcontroller model, the microcontroller family, the microcontroller step or the microcontroller inspection number, the size and type of internal storage element 3 or the type of programming of internal storage element 3.

Microcontroller 1 is part of a control unit 7 for controlling/regulating technical operations and processes particularly in a motor vehicle. A control program executable on microprocessor 2 of microcontroller 1 is stored in an external storage element 8. The control program is be adjusted to the scope of the features of microcontroller 1 (which command sequences are allowed to be included in the control program?), to the faulty features (which command sequences should be avoided, and using which workarounds can they be by-passed?), and to the hardware of microcontroller 1.

The present invention proposes that the run of the control program be controlled as a function of the information regarding the hardware of microcontroller 1 stored in information register 6 (see FIG. 3). After the method according to the present invention is started in functional block 30, information regarding the hardware of microcontroller 1 is first read in from information register 6 in functional block 31. In functional block 32, switches, via which the run of the control program can be influenced, are set as a function of the information read in. Subsequently, the control program is executed with the set switches, which is symbolically represented by functional block 33. The method is ended in functional block 34.

With the aid of the switches, command sequences for specific features of microcontroller 1 or for specific workarounds can be activated or deactivated. Furthermore, the control program can be adapted via the switches to the hardware of microcontroller 1. Thus, for example, information regarding the type and size of internal storage element 3 and/or of external storage element 8 defines within which storage areas internal storage element 3 can be accessed and/or the external storage is accessed. For reasons of shorter access times, internal storage element 3 is preferably accessed. If adaptation values and/or diagnostic values are stored in internal storage element 3 during the program run, the information regarding the size of internal storage element 3 can be used to determine to what extent these values are stored. For example, in the case of a small internal storage element 3, only part of the theoretically storable values can be stored. Using the information regarding the type of programming of internal storage element 3, the programming algorithms stored in the control program can be adapted.

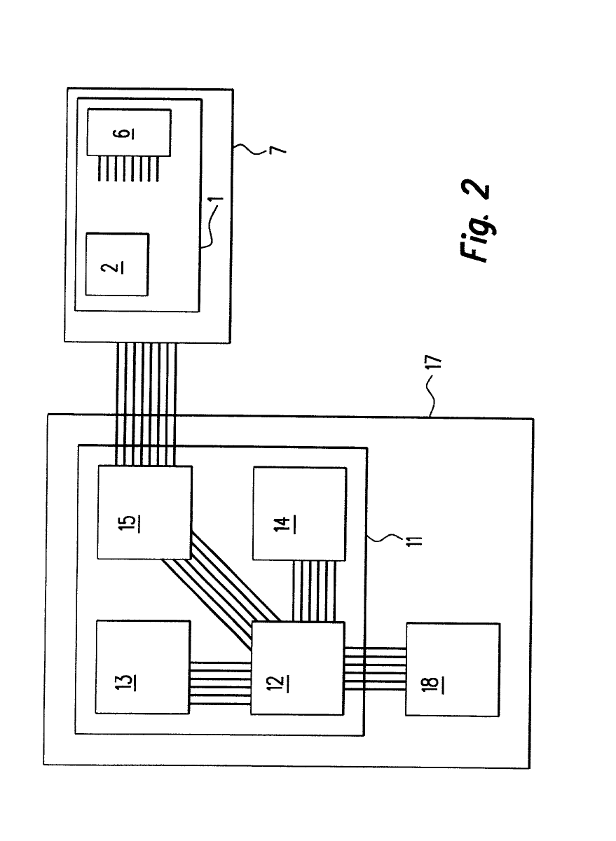

In FIG. 2, a second exemplary embodiment of the microcontroller according to the present invention is designated in its entirety by reference numeral 11. Microcontroller 11 has a microprocessor 12, an internal storage element 13 configured as a flash memory, an analog/digital (A/D) converter 14, and a databus 15 configured as a controller area network (CAN) bus. Microcontroller 11 is connected to a control unit 7 via databus 15. Control unit 7 has an additional microcontroller 1, which, among other things, also has an information register 6, in which information regarding the hardware of microcontroller 1 is stored in a retrievable manner.

Microcontroller 11 is part of a testing device 17 for testing additional microcontroller 1, the complete control unit 7, and/or a control program executable on at least one microprocessor 2 of additional microcontroller 1, for controlling/regulating technical operations and processes, in particular in a motor vehicle. A test program executable on microprocessor 12 of microcontroller 11 is stored in an external storage element 18. The test program is adjusted to the scope of features of additional microcontroller 1 (which components of additional microcontroller 1 and which command sequences of the control program are allowed to be tested by the test program?), to the faulty features (which components and which command sequences should be avoided by the test program?), and to the hardware of microcontroller 1 in order to be able to test additional microcontroller 1 and the control program, respectively, in the most thorough, exact, and reliable manner possible.

Individual components 2, 3, 4, 5, 6, 8, and 12, 13, 14, 15, 16, 18 of microcontrollers 1, 11 are connected to each other either via physical lines or via at least one databus.

The present invention proposes that the run of the test program be controlled as a function of the information regarding the hardware of microcontroller 1, stored in information register 6 of additional microcontroller 1 (see FIG. 3). After the method according to the present invention is started in functional block 30, information regarding the hardware of microcontroller 1 is first read in from information register 6 in functional block 31. In functional block 32, switches, via which the run of the test program on microprocessor 12 of microcontroller 11 can be influenced, are set as a function of the information read in. Subsequently, the test program is executed with the set switches, which is symbolically represented by functional block 33. The method is ended in functional block 34.

What is claimed is:

1. A method for controlling a run of a program executable on at least one microprocessor of a microcontroller, comprising the steps of:
reading in information regarding a hardware of the microcontroller from at least one information register of the microcontroller; and
actuating at least one switch via which the program run is controlled as a function of the information read in.

2. The method according to claim 1, wherein:
the information read in corresponds to at least one of the at least one microprocessor of the microcontroller and at least one additional component of the microcontroller.

3. The method according to claim 1, further comprising the step of:
controlling a run of a test program that is executable on the at least one microprocessor of the microcontroller of a testing device and is for testing at least one of an additional microcontroller, a control unit, and a control program executable on at least one microprocessor of the additional microcontroller, the controlling being performed as a function of information regarding a hardware of the additional microcontroller.

4. The method according to claim 1, further comprising the step of:
controlling a run of a control program that is executable on the at least one microprocessor of the microcontroller of a control unit and is for controlling/regulating technical operations and processes, the controlling being performed as a function of the information regarding the hardware of the microcontroller.

5. The method according to claim 4, wherein:
the technical operations and processes relate to a motor vehicle.

6. A control element for one of a control unit of an internal combustion engine and for a testing device for testing at least one of a microcontroller, the control unit, and a program executable on at least one microprocessor of the microcontroller, comprising:
a storage medium storing another program that can be executed on a computing element, the other program causing the computing element to:
read in information regarding a hardware of the microcontroller from at least one information register of the microcontroller, and
actuate at least one switch via which a program run is controlled as a function of the information read in.

7. The control element according to claim 6, wherein:
the computing element includes the at least one microprocessor.

8. The control element according to claim 6, wherein:
the storage medium includes one of a read only memory and a flash memory.

9. The control element according to claim 6, wherein:
the internal combustion engine is of a motor vehicle.

10. A microcontroller, comprising:
at least one microprocessor including a program that is executable on the at least one microprocessor;
at least one information register;
an arrangement for reading in information regarding a hardware of the microcontroller from the at least one information register; and
at least one switch actuatable as a function of the information read in and for controlling a run of the program executable on the at least one microprocessor.

11. The microcontroller according to claim 10, wherein:
the information read in corresponds to at least one of the at least one microprocessor of the microcontroller and at least one additional component of the microcontroller.

12. The microcontroller according to claim 11, wherein:
the information regarding the at least one additional component of the microcontroller includes information about at least one of an internal storage element, an analog/digital (A/D) converter, a digital/analog (D/A) converter, and at least one databus.

13. The microcontroller according to claim 10, wherein:
the microcontroller is part of a testing device for testing at least one of an additional microcontroller, a control unit, and the program executable on the at least one microprocessor.

14. The microcontroller according to claim 10, wherein:
the microcontroller is part of a control unit for controlling/regulating technical operations and processes.

15. The microcontroller according to claim 14, wherein:
the technical operations and processes relate to a motor vehicle.
